(19) United States
(12) Patent Application Publication
(10) Pub. No.: US 2007/0188838 A1
(43) Pub. Date: Aug. 16, 2007

(54) Real-time pattern recognition processor using holographic photopolymer and method of use thereof

(75) Inventors: Tien-Hsin Chao, Valencia, CA (US); J. Kevin Cammack, Palo Alto, CA (US)

Correspondence Address: MARJAMA & BILINSKI LLP, 250 SOUTH CLINTON STREET, SUITE 300, SYRACUSE, NY, 13202, US

(73) Assignee: California Institute of Technology, Pasadena, CA (US)

(21) Appl. No.: 11/654,197

(22) Filed: Jan. 17, 2007

Related U.S. Application Data
(60) Provisional application No. 60/759,603, filed on Jan. 17, 2006.

(51) Int. Cl. G03H 1/16

(52) U.S. Cl. 359/29

(57) ABSTRACT

We have designed, built and operated an innovative JTOC system utilizing a holographic photopolymer as the square law detector to record the holographic data for one-step correlation signal requisition in real time. The resultant high-resolution, high-speed JTOC is useful to perform real-time pattern recognition. An example application that has been demonstrated is fingerprint verification.

### CROSS-REFERENCE TO RELATED APPLICATIONS

This application claims priority to and the benefit of co-pending U.S. provisional patent application Ser. No. 60/759,603, filed Jan. 17, 2006, which application is incorporated herein by reference in its entirety.

### STATEMENT REGARDING FEDERALLY FUNDED RESEARCH OR DEVELOPMENT

The invention described herein was made in the performance of work under a NASA contract, and is subject to the provisions of Public Law 96-517 (35 USC 202) in which the Contractor has elected to retain title.

### FIELD OF THE INVENTION

The invention relates to pattern recognition in general and particularly to a pattern recognition processor that employs a holographic photopolymer film.

### BACKGROUND OF THE INVENTION

Pattern recognition processors are increasingly being used for commercial and security applications. For example, the use of biometrics for user verification is becoming more common in high-security applications. Many such systems, mostly implemented with digital electronics, will develop a template from a legitimate user (enrollment) and subsequently verify his identity (verification). To date, fingerprints are the most common type of biometric pattern that is used for verification. Many systems have been developed to accomplish fingerprint verification using feature-based algorithms. The most popular one is minutiae extraction. However, the major drawback of minutiae based systems are their vulnerability to errors due to point defects such as scars. Applications based on other types of biometric indicators are also being developed, for example image-based systems using retinal scans, and audio systems using voice prints.

An alternative for biometric pattern recognition is the optical correlator technology. To date, the most successful system architecture developed for optical processing is the optical correlator; The primary advantages of the optical correlator are its vast parallelism and shift invariance. The parallelism enables the recognition of multiple targets simultaneous presenting in the input plane. The shift invariance enables the detection of a target anywhere within the field of view by using only one processing step. This is in contrast with the non-shift-invariant digital processing approach with which a new computation has to be performed repetitively, for as little as a small change in the target location.

By using an optical correlator for pattern recognition, the input target template can be correlated against a reference template at the speed of light and the system throughput speed is only limited to the update speed of the system I/O and the correlator template. There are two types of prior art optical correlators: the Vander Lugt optical correlator (VLOC); and the Joint Transform Optical Correlator (JTOC).

FIG. 1 is a schematic diagram of a prior art 4-f Vander Lugt Optical Correlator. The system consists of a collimated laser source, a input Spatial Light Modulator (SLM) placed at the input plane for target data input, a pair of Fourier Transform (FT) lenses for Fourier transform and inverse Fourier transform respectively, a correlation filter SLM placed at the Fourier transform plane for storing the pre-computed correlator filter, and a photodetector array placed at the output correlation plane for capturing the correlation peak signal. The input SLM, FT lens, filter SLM, inverse FT lens, and the photodetector array are placed in tandem with a precise spacing of the focal length f of the FT lenses. This architecture is often referred as the 4-f system.

The basic advantage of the VLOC is that a vast database of target templates can in principle be precomputed and can form a Fourier correlation filter bank. However, the major limitation of the VLOC in many applications, such as biometric pattern recognition applications, is that the correlation filter computation is very time-consuming and requires appreciable digital computing resources for rapid updating of the reference database. Moreover, to accommodate all the possible target variations such as scale, orientation, perspective changes, a very complex distortion invariant filter synthesis algorithm has to be developed. This not only will further increase the complexity and resources needed for the filter preparation but also will present a higher security risk even after the distortion correlation filter design has been optimized.

There is a need for a high speed, high throughput pattern recognition processor.

### SUMMARY OF THE INVENTION

In one aspect, the invention relates to a pattern recognition processor. The pattern recognition processor comprises a first optical path comprising a first spatial light modulator and a first Fourier lens, the first spatial light modulator configured to accept an input digital image and the first Fourier lens providing a spectrum of the input digital image; a second optical path comprising a second input spatial light modulator and a second Fourier lens, the second spatial light modulator configured to accept a reference digital image and the second Fourier lens providing a spectrum of the reference digital image, the second optical path oriented in a non-parallel orientation to the first optical path; a holographic film having a response time and an erase time, the holographic film situated at an intersection of a common Fourier transform plane of the spectrum of the input digital image and the spectrum of the reference digital image, the holographic film configured to record the holographic interference fringes that are formed as a hologram; a first laser for illuminating the first spatial light modulator, the first Fourier lens, the second spatial light modulator, and the second Fourier lens to record the hologram, the first laser illuminating the holographic film from a first side; and a second laser source configured to propagate a laser beam through the holographic film from a side different from the first side, a third Fourier lens configured to perform an inverse Fourier transform, and a sensor configured to sense a correlation output signal.

In one embodiment, the holographic film is a holographic photopolymer film. In one embodiment, the record time of the holographic film is comparable to a single video frame display time. In one embodiment, the erase time is substantially instantaneous.

The invention also provides a real-time pattern recognition system. The real-time pattern recognition system comprising the previously described pattern recognition processor and additionally a source of a digital input image for the first spatial light modulator; a source of a reference input image for the second spatial light modulator; and a controller and analyzer comprising a general purpose programmable computer and control software configured to control the operation of the real-time pattern recognition system, and to perform a responsive action based at least in part upon the correlation output signal.

In one embodiment, the source of a digital image for the first spatial light modulator is a source of biometric images. In one embodiment, the source of biometric images is a fingerprint reader.

In another aspect, the invention relates to a method of pattern recognition in real time. The method comprises the steps of providing the previously described pattern recognition processor; providing a digital input image to the first spatial light modulator; providing a reference input image to the second spatial light modulator; illuminating the first optical path and the second optical path with the first laser; recording a hologram on the holographic film; illuminating the recorded holographic film with the second laser; sensing a correlation output signal with the sensor; and determining a value for a cross-correlation of the input image and the reference image.

In one embodiment, the method of pattern recognition in real time further comprises the step of taking an action based at least in part on the value of the cross-correlation of the input image and the reference image. In one embodiment, the action is taken is responsive to a successful matching of the input image and the reference image. In one embodiment, the action is taken is responsive to an unsuccessful matching of the input image and the reference image. In one embodiment, the operation of the first laser and the second laser is performed in pulsed mode, the first laser and the second laser operating in succession. In one embodiment, the operation of the first laser and the second laser is performed repeatedly in pulsed mode. In one embodiment, the operation of the first laser and the second laser is performed in substantially real time. In one embodiment, the operation of the first laser and the second laser is performed in substantially a time required to display a single video frame.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 is a schematic diagram of a prior art 4-f Vander Lugt Optical Correlator.

FIG. 2 illustrates a conventional prior art Joint Transform Optical Correlator operated in two clock cycles for data recording and correlation signal retrieval, respectively.

FIG. 3 is a schematic diagram of a real-time JTOC system using a holographic photopolymer film, according to principles of the invention.

FIG. 4a is a diagram showing the response time for the holographic photopolymer film used in an embodiment of the real-time JTOC system of FIG. 3.

FIG. 4b is a diagram showing the erase time for the holographic photopolymer film used in an embodiment of the real-time JTOC system of FIG. 3.

FIG. 5a is an image of fingerprint sample 1.

FIG. 5b is an image of an autocorrelation of fingerprint sample 1 that was obtained using the apparatus of the invention.

FIG. 5c is an image of fingerprint sample 1 with a 90 degree clockwise rotation relative to the image shown in FIG. 5a.

FIG. 5d is an image of a cross-correlation of fingerprint sample 1 and its rotated version that was obtained using the apparatus of the invention.

FIG. 6a is an image of fingerprint sample 2.

FIG. 6b is an image of a cross-correlation between fingerprint sample 1 and fingerprint sample 2 that was obtained using the apparatus of the invention.

FIG. 7a is an image of fingerprint sample 3.

FIG. 7b is an image of an autocorrelation of fingerprint sample 3 that was obtained using the apparatus of the invention.

FIG. 7c is an image of fingerprint sample 4.

FIG. 7d is an image of an autocorrelation of fingerprint sample 4 that was obtained using the apparatus of the invention.

FIG. 7e is an image of a cross-correlation between fingerprint sample 3 and fingerprint sample 4 that was obtained using the apparatus of the invention.

FIG. 8 is an illustrative functional block diagram of a fingerprint verification/identification system.

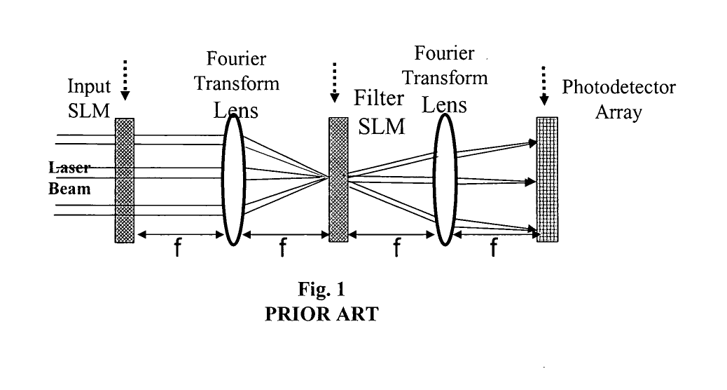

### DETAILED DESCRIPTION OF THE INVENTION

We have designed, built and operated an innovative all-optical Joint Transform Optical Correlator (JTOC) system utilizing a high-speed rewritable holographic photopolymer film (HPF) as the read/write medium (or square law detector) to record the holographic data for one-step correlation signal acquisition in real time. The high resolution HPF has enabled the use of an off-axis holographic recording scheme that completely eliminates the zero-order crosstalk plaguing most of the prior art JTOC systems that rely on an on-axis recording scheme. The high sensitivity and fast erasure capability of the HPF film make possible the real-time updatable target recognition performance of the JTOC. The resultant high-resolution, high-speed JTOC is useful to perform real-time pattern recognition. The JTOC system architecture and an optical implementation embodiment are described herein. An example application that has been demonstrated is fingerprint verification, although many other applications are possible.

As used herein, the term “JTOC” is used to represent either a “Joint Transform Optical Correlator” apparatus or the language “joint transform optical correlation” which is used to represent an action or the result of the action. “JTOC” is understood to denote a device (or its output signal or result) comprising two optical systems or two optical paths in which two input signals are simultaneously transformed to produce their spectra, and these spectra are multiplied and inversely transformed to produce an output signal, which output signal represents at least in part one correlation between the two input signals.

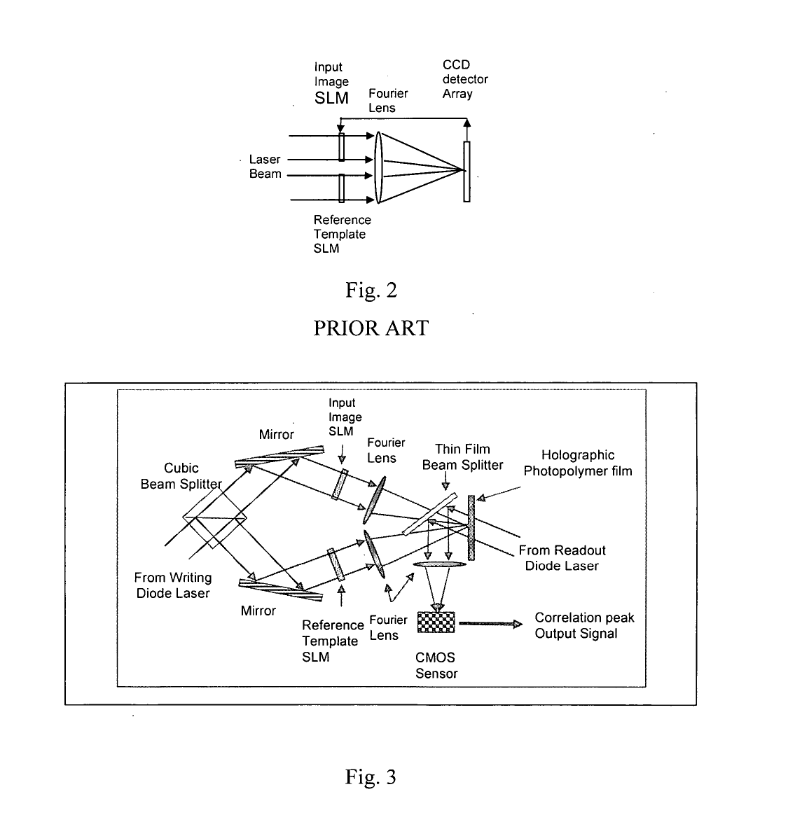

We will describe first a conventional prior art JTOC, as illustrated in FIG. 2. A collimated laser beam is used as the light source. In the input plane, two SLMs are placed side-by-side with a predetermined spatial separation. As shown in FIG. 2, the upper SLM is used to display a real-time input biometric pattern (e.g., from a fingerprint scanner, or from a digital camera that records a retina scan image or other biometric image). The lower SLM is used to display a reference pattern, typically stored in a digital memory and recovered for display. A Fourier transform (FT) lens is placed at a distance f behind the input plane. A CCD detector array is placed at the back focal plane of the FT lens, and used as a “square law” recorder. Similarly, a holographic recording medium can also be used to record the interference pattern by recording the total irradiance, or intensity of the total light amplitude, at the plane of the recording medium. Conventionally, in order to simplify the system, a two-step process is used to perform the complete JTOC operation. In step one, the CCD is activated to record (e.g., “frame grab”) the interference pattern formed between the input and reference biometric pattern and save it in an onboard buffer memory. In step two, the CCD recorded interference pattern is fed back into the input SLM. The reference SLM is turned off at this time. The interference pattern is then Fourier transformed and, at the FT plane, the joint transform correlation signal between the original input and the reference is displayed. A sharp correlation peak appears when the two patterns are matched. This correlation signal is then recorded (or is “frame grabbed”) by the CCD and displayed to the output monitor. Based on the appearance and sharpness of the correlation peak or based on its absence, one can deduce (or recognize) whether the input pattern or image and the reference pattern or image are well matched, or are dissimilar in some regard.

An JTOC is very suitable for real-time comparison of an input biometric pattern (e.g., a fingerprint or a retinal scan) directly with that of a pre-stored sample of the same pattern. Since the JTOC performs instantaneous recognition continuously, the input pattern can be maneuvered (e.g., rotated back and forth and/or translated ) until the matching is achieved (if the input and reference originated from the same object) or the matching can be confirmed as failed (if the input and the reference patterns come from different objects). It is not necessary to pre-compute the large bank of distortion invariant correlation filters as is needed by the Vander Lugt Optical Correlator. Therefore, an ideal JTOC is a good choice for real-time biometric pattern recognition applications, or for other real-time image comparisons.

However, the prior art JTOC, as shown in FIG. 2, suffers several drawbacks and needs further performance upgrading to meet the real-time pattern recognition challenge such as fingerprint verification. The drawbacks include at least the following two limitations.

First, a CCD has low spatial resolution and is not an ideal square law detector for recording holographic interference fringes. For example, a state-of-the-art CCD possesses of the order of 1000 pixels (in one-dimension) with a pixel pitch of 10 microns. This results in a resolution of only about 100 lines/mm. This resolution is far less than the greater than 2000 lines/mm resolution of the holographic photopolymer used in the embodiment described in the present disclosure. Moreover, the joint transform Fourier spectrum recorded by the low spatial-resolution CCD will result in overlapping of the DC term (a much brighter bias spot) and correlation term in the output correlation plan and will severely limit the correlation signal signal-to-noise ratio.

Second, a two-step operation process is needed to capture the correlation signal by using a CCD as the recorder. Since most of the commercial CCDs with low to medium cost are limited to low frame rate (around video rate), the overall throughput rate using a commercial CCD will be even slower.

FIG. 3 is a schematic diagram of a JTOC system using a high-resolution holographic photopolymer film (“HPF”) as the real-time holographic recording medium. An innovative off-axis JTOC architecture is used that takes advantage of the high-spatial resolution provided by the HPF. This off-axis design enables the separation the output correlation plane from that of the convolution plane (as opposed to the conventional on-axis JTOC architecture as illustrated in FIG. 2). This is a unique advantage obtained through the use of the HPF.

As shown in FIG. 3, a collimated writing laser beam, derived from a coherent diode laser source, is first split into two orthogonal parts after passing through a cubic beam splitter. An input image is provided from a source, such as a fingerprint scanning apparatus, or in other embodiments, from any convenient source of digital image information. Input images can be are provided in various ways. For example, a fingerprint can be obtained using a capacitive sensor or an optical sensor, a retinal scan can be input using an optical imaging system, and a general image can be input using a digital camera, a tv system, a digitized image taken with a film camera, and/or a digital image generated in a computer. The upper beam illuminates the input SLM and is then optically Fourier transformed by a FT lens. A reference image in digital form is provided to a reference SLM. Similarly, the lower beam illuminates the reference SLM and generates the FT spectrum of the reference image by optical Fourier transform by a second FT lens. In the usual case, a reference image is provided from a memory as a recorded digital image. However, reference images can in principle be provided in the same manner as input images. The spectra of the input and reference images intersect at the center of the Fourier transform plane. Holographic interference fringes are formed and are recorded with the holographic photopolymer film placed over the Fourier transform plane.

A readout laser beam originates from a second diode laser (incoherent to the writing diode laser beam but with the same or different wavelength). The second laser beam is used to illuminate the HPF from the opposite side from the writing beam. This second laser beam is directed into the counter propagation direction of that of the laser that illuminates the input SLM. A thin film beam splitter is placed between the input FT lens and the HPF to intercept the readout beam that exits from the holographic photopolymer film and reflects the exiting readout beam toward a third FT lens for inverse Fourier transform. A digital photodetector array is placed at the back focal plane of this third FT lens to capture the correlation output signal. Thus, when the input scene contains a target image that matches with that of the reference image, a sharp correlation peak signal appears at the location of the centroid of the input image.

As a consequence of the high-speed recording and low data retention time characteristics of the HPF, real-time holograms can be continuously recorded (with pulsing of the input laser source in synchronism with the SLM update rate) and be continuously read out with the readout laser. Therefore, real-time correlation operations can be achieved without any interruption. This innovative JTOC system architecture is capable of eliminating all of the enumerated limitations or drawbacks associated with the prior art JTOC.

An operational JTOC breadboard has been constructed and utilized to demonstrate that pattern recognition can be accomplished according to the description presented herein. In the operational JTOC, according to FIG. 3, two He—Ne lasers each emitting a line at 632.8 nm were utilized as the data recording and readout light sources, respectively. A pair of Kopin LCD SLMs (model no. 230K available from Kopin Corporation, 125 North Drive, Westborough, Mass. 01581)were utilized to hold the input and reference images respectively. A HPF produced by the Nitto Denko Technical Corporation (NDT, 501 Via Del Monte, Oceanside, Calif. 92054) was utilized as the holographic recording medium. A discussion of suitable holographic potopolymer films is provided in one or more of U.S. Pat. No. 6,610,809 to Yamamoto et al., U.S. Pat. No. 6,653,421 to Yamamoto et al., U.S. Pat. No. 6,809,156 to Yamamoto, and U.S. Pat. No. 7,067,230 to Cammack et al. A digital CCD camera was used to capture the correlation output. For the examples described herein, fingerprint images were generated using a fingerprint reader from a Thinkpad® Notebook. Examples of fingerprint readers that can be used to obtain an image of a portion of a finger comprising a fingerprint include the Microsoft Fingerprint Reader available from Microsoft Corporation, or the model P3400, P4000 or P5000 biometric readers available from Zvetco Biometrics, LLC, 6820 Hanging Moss Rd., Orlando, Fla. 32807. An integrated fingerprint reader is available on select ThinkPad® notebooks available from Lenovo Group Limited, One Manhattanville Road, Suite PH, Purchase, N.Y. 10577-2100.

Performance Characteristics of a NDT HPF Sample

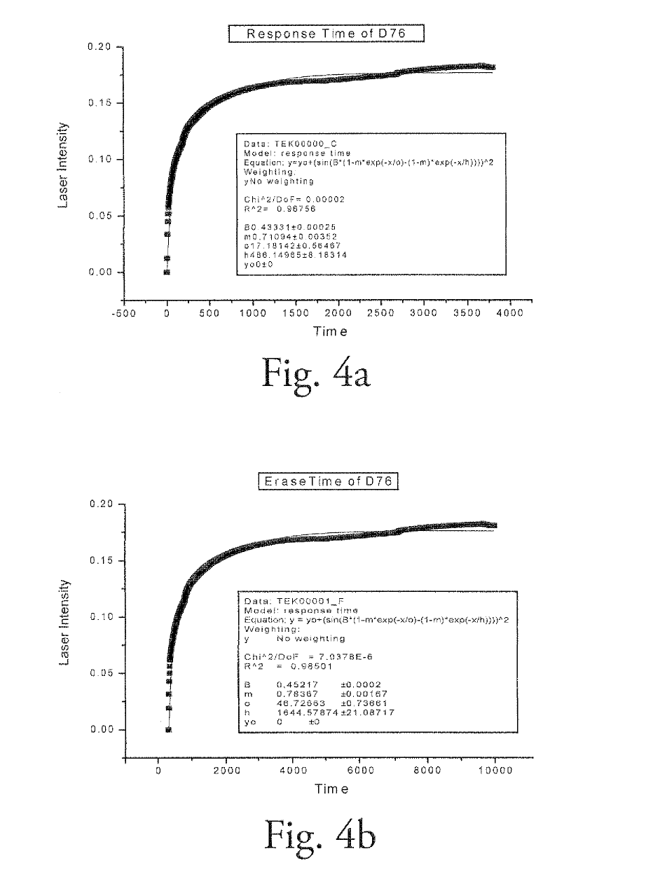

We have obtained samples of HPF from NDT. The measured performance characteristics are shown in FIGS. 4a and 4b. The NDT HPF sample was measured using a 4-wave mixing scheme. A 8 kV dc voltage was applied to the film during operation. A recorded hologram can be instantly erased after the dc bias is removed. FIG. 4a is a diagram showing the response time for the holographic photopolymer film (D76 at 8 KV with 0.13 W/cm² laser intensity) used in an embodiment of the real-time JTOC system of FIG. 3. The measured output laser intensity is in arbitrary units. The data is given in dark squares, and a theoretical analysis is given by a thin continuous line, much of which falls directly on the recorded data points. The response time is inversely proportional to the writing laser intensity. We have utilized a 30 mW laser source. The focused laser spot at the FT plane was about 1 mm in diameter. The time axis is given in units of milliseconds. The observed response time is at about the video frame rate, or is comparable to a single video frame display time. FIG. 4b is a diagram showing the erase time for the holographic photopolymer film (of D76 at 8KV with 0.065 W/cm² laser intensity) used in an embodiment of the real-time JTOC system of FIG. 3. The data is given in dark squares, and a theoretical analysis is given by a thin continuous line, much of which falls directly on the recorded data points. The erase time is measured as function of readout laser power. The time axis is given in units of milliseconds.

While the present embodiment is described in terms of a holographic photopolymer film, it is expected that any holographic film having substantially similar record times and erase times can in principle be substituted for the holographic photopolymer film used.

Demonstration of Finger Print Recognition

We have investigated the JTOC performance and its applications to fingerprint recognition. Several fingerprint samples, taken from various conditions were used as the input objects.

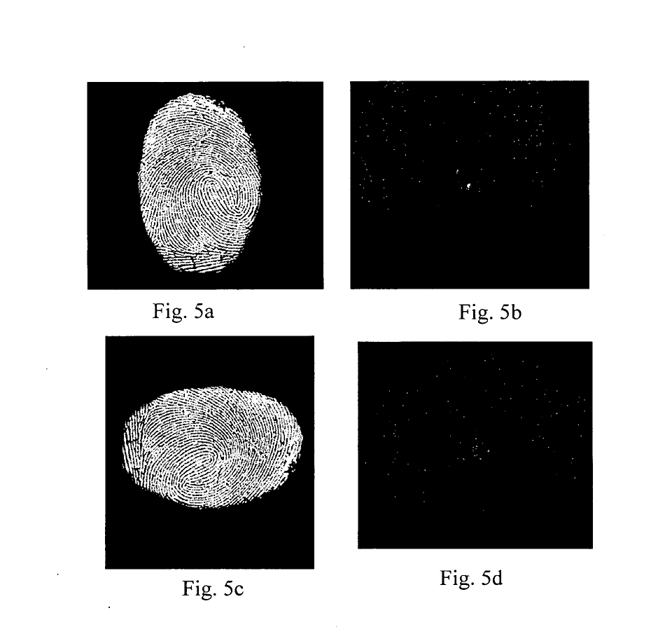

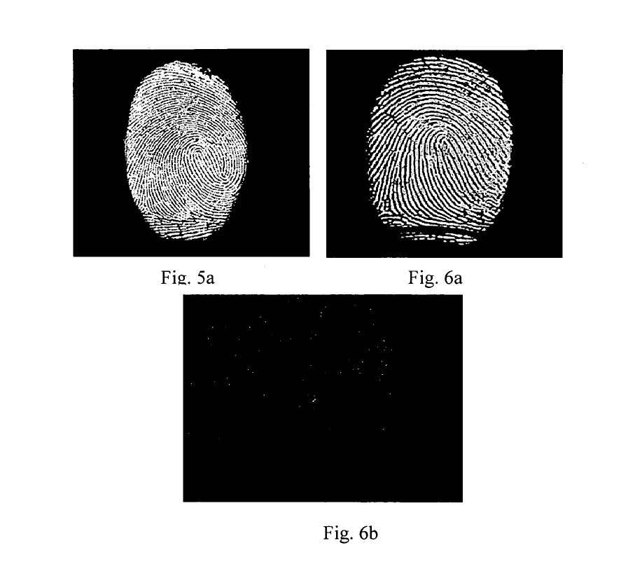

FIG. 5a is an image of fingerprint sample 1. FIG. 5b is an image of an autocorrelation of fingerprint sample 1 that was obtained using the apparatus of the invention. FIG. 5c is an image of fingerprint sample 1 with a 90 degree clockwise rotation relative to the image shown in FIG. 5a. FIG. 5d is an image of a cross-correlation of fingerprint sample 1 and its rotated version that was obtained using the apparatus of the invention. As shown in FIGS. 5a and 5b, fingerprint sample 1 gave a successful autocorrelation output. By comparison, the cross-correlation output level was very low by correlating the sample with its 90 degree rotated version, as seen in FIG. 5d.

FIG. 6a is an image of fingerprint sample 2. FIG. 6b is an image of a cross-correlation between fingerprint sample 1 and fingerprint sample 2 that was obtained using the apparatus of the invention. FIG. 6b shows the low cross-correlation output between fingerprint sample 1 and a different fingerprint sample 2. For the convenience of the reader, a duplicate copy of FIG. 5a (fingerprint 1) is shown next to FIG. 6a.

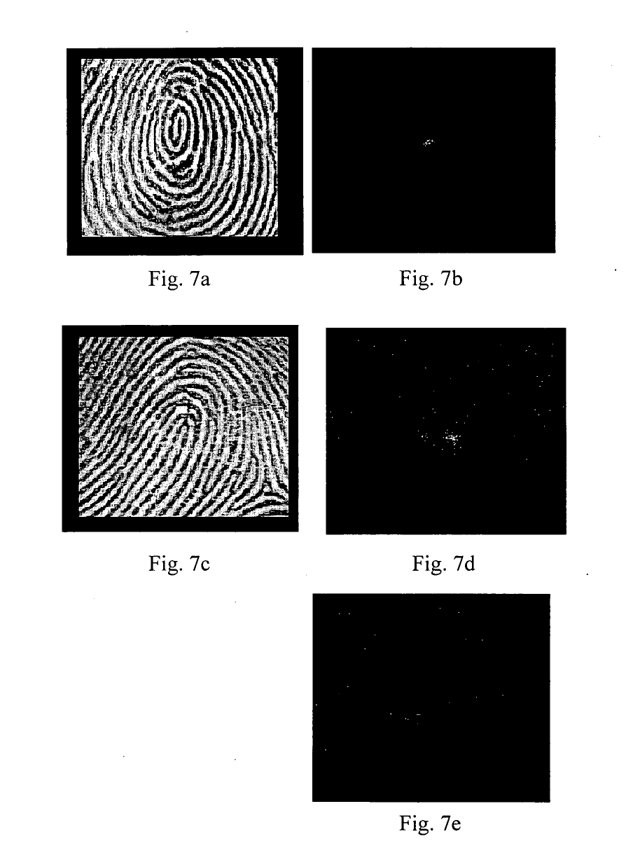

FIGS. 7a through 7e show another example that relates to the comparison of two distinct fingerprints. FIG. 7a is an image of fingerprint sample 3. FIG. 7b is an image of an autocorrelation of fingerprint sample 3 that was obtained using the apparatus of the invention. FIG. 7c is an image of fingerprint sample 4. FIG. 7d is an image of an autocorrelation of fingerprint sample 4 that was obtained using the apparatus of the invention. FIG. 7e is an image of a cross-correlation between fingerprint sample 3 and fingerprint sample 4 that was obtained using the apparatus of the invention. FIGS. 7b and 7d show correlation outputs that demonstrate the high-peak autocorrelation signal of fingerprint sample 3 and that of fingerprint sample 4, respectively. By comparison, as shown in FIG. 7e, the cross-correlation output between the two fingerprint samples was very low.

These examples of correlation tests demonstrate the JTOC pattern recognition capability of the described JTOC apparatus comprising a HPF. They also specifically demonstrate the applicability of this JTOC processor for fingerprint recognition.

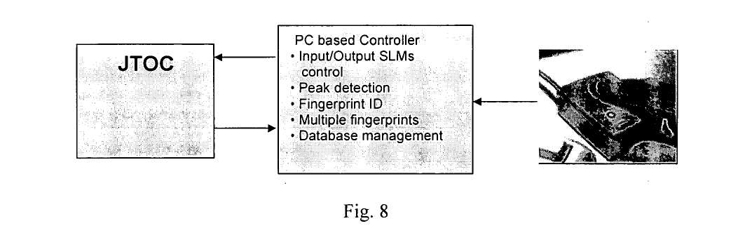

A functional block diagram of a fingerprint verification/identification system is shown in FIG. 8. A fingerprint scanner is used to acquire reference images to establish a reference database as well as the input image. A PC-based controller is used to perform Input/Output data interface and control, correlation peak signal detection and fingerprint identification. In one embodiment, the PC-based controller uses a conventional commercially available general purpose programmable computer operating under the control of software instructions prepared using any conventional programming language. The PC-based controller interfaces with the Joint Transform Optical Correlator that has been described previously in connection with FIG. 3.

In conclusion, we have developed and demonstrated a new JTOC system architecture utilizing a high-speed and high-sensitivity HPF as the holographic recording material. The high resolution HPF has enabled the recording using an off-axis holographic recording scheme that completely eliminates the zero-order crosstalk that has plagued most of the state-of-the-art JTOC systems with an on-axis recording scheme. A real-time updatable JTOC system has been demonstrated for pattern recognition applications such as finger print recognition. A real-time pattern recognition system can be constructed, comprising the pattern recognition processor that has been described, a source of a digital input image for the first spatial light modulator (such as a fingerprint scanner device), a source of a reference input image for the second spatial light modulator (such as a memory containing one or more pre-recorded digital images); and a controller and analyzer comprising a general purpose programmable computer and control software configured to control the operation of the real-time pattern recognition system, and to perform a responsive action based at least in part upon a correlation output signal.

Theoretical Discussion

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

Derivation of the Off-Axis OJTC System Architecture

In order to provide more insight into the principle of operation of the OJTC system, the theoretical background of an OJTC is provided as follows, and is to be read with reference to FIG. 3:

In a JTOC, the input image, s(x,y), is correlated against a target image, h(x,y). Their corresponding Fourier transforms, expressed as S(fₓ, f_{y}) and H(fₓ, f_{y}) respectively, are overlapped at the Fourier transform plan.

The light distribution of the overall spectra is:
O_{H}(fₓ, f_{y})=S(fₓ, f_{y})+H(fₓ, f_{y})
This joint transform spectrum Oₕ(fₓ, f_{y}) will be recorded by the NDT holographic photopolymer as a square law detector.

The recorded data is [Oₕ(fₓ, f_{y})]² that can be elaborated as:

$$\begin{matrix}{\vert {O}_{H} ( {f}_{x} , {f}_{y} ) \vert}^{2} = ( S ( {f}_{x} , {f}_{y} ) + H ( {f}_{x} , {f}_{y} ) ) \times {( S ( {f}_{x} , {f}_{y} ) + H ( {f}_{x} , {f}_{y} ) )}^{*} \\ {\vert S ( {f}_{x} , {f}_{y} ) \vert}^{2} + ( S ( {f}_{x} , {f}_{y} ) \times {H ( {f}_{x} , {f}_{y} )}^{*} ) + \\ ( H ( {f}_{x} , {f}_{y} ) + {S ( {f}_{x} , {f}_{y} )}^{*} ) + {\vert H ( {f}_{x} , {f}_{y} ) \vert}^{2}\end{matrix}$$

where * denotes the complex conjugate.

The recorded hologram [Oₕ(fₓ, f_{y})]² after inverse Fourier transformed can be expressed as:

$${F}^{- 1} ( {\vert {O}_{H} ( {f}_{x} , {f}_{y} ) \vert}^{2} ) = [ \begin{matrix}( S ( {f}_{x} , {f}_{y} ) ⊗ S ( {f}_{x} , {f}_{y} ) ) + ( S ( {f}_{x} , {f}_{y} ) ⊗ H ( {f}_{x} , {f}_{y} ) ) + \\ ( H ( {f}_{x} , {f}_{y} ) ∘ S ( {f}_{x} , {f}_{y} ) ) + ( H ( {f}_{x} , {f}_{y} ) ⊗ H ( {f}_{x} , {f}_{y} ) )\end{matrix} ]$$

where [symbol] and ° denote the cross-correlation and convolution operations respectively.

In the right hand side of above equation, the first term and the fourth term are the autocorrelation of the input image and reference image respectively. Theses terms may be safely ignored. The second term is the cross-correlation between the input and the reference image. The third term is the convolution between the input and the reference.

As a result of the off-axis holographic recording geometry, the cross-correlation term and the convolution term are widely spatially separated. Specifically, the readout arrangement shown in FIG. 3 has been designed to retrieve only the cross-correlation term. Therefore, the output CMOS detector will only detect the correlation signals as described in the second term (S(fₓ, f_{y}) [symbol] H(fₓ, f_{y})) as shown in the previous equation.

Other Applications

In other embodiments, the systems and methods described are expected to be useful for spacecraft landmark tracking. In this application, a previously obtained landing site sequence image (recorded for example through an onboard telescope) can be stored. Continuous joint transform correlation can be performed between the landing camera video and the landing site (a subset of the landing video image). Because the altitude of a craft above a surface can be known (for example by radar measurement), the right sequence of the landing site data can be loaded from memory. This will enable the spacecraft to determine where the landing site is situated during descent and to make corrections accordingly.

Another application is expected to be the correction of imaging sensor jitter and/or vibration. The relative frame-to-frame motion of the camera can be detected by performing continuous joint transform correlation between two consecutive images. The correlation output can be used to compensate the motion or jittering of the camera.

In some embodiments, the output signal can be processed by a general purpose programmable computer in several ways. For example, one can use a “successful” output (e.g., a successful matching of the input image and the reference image) as a means of authentication, and one can use a “failed” output (e.g., an unsuccessful matching of the input image and the reference image) as a means of indicating that an expected image (for example from a surveillance camera) has changed. In some embodiments, for example if the issue is authenticating a person's identity (and any associated privileges that the person enjoys), in the “successful” case, one can allow physical access to a space or electronic access to a system or to files, and in the “failed” case, one can withhold or deny access. In the case of repeated “failed” outputs, one may take other remedial action, such as shutting down the system or issuing an alarm. In other embodiments, for example in a surveillance situation, one can use the information in the “failed” case (e.g., the case where a scene is different from an expected or reference scene), to turn on a recorder connected to a surveillance camera, to issue an alarm, or to take other action as may be considered reasonable under the circumstances, while in the “successful” case (e.g., no change in the scene under surveillance) to take no action.

General Purpose Programmable Computers

General purpose programmable computers useful for controlling instrumentation, recording signals and analyzing signals or data according to the present description can be any of a personal computer (PC), a microprocessor based computer, a portable computer, or other type of processing device. The general purpose programmable computer typically comprises a central processing unit, a storage or memory unit that can record and read information and programs using machine-readable storage media, a communication terminal such as a wired communication device or a wireless communication device, an output device such as a display terminal, and an input device such as a keyboard. The display terminal can be a touch screen display, in which case it can function as both a display device and an input device. Different and/or additional input devices can be present such as a pointing device, such as a mouse or a joystick, and different or additional output devices can be present such as an enunciator, for example a speaker, a second display, or a printer. The computer can run any one of a variety of operating systems, such as for example, any one of several versions of Windows, or of MacOS, or of Unix, or of Linux.

Machine-readable storage media that can be used in the invention include electronic, magnetic and/or optical storage media, such as magnetic floppy disks and hard disks; a DVD drive, a CD drive that in some embodiments can employ DVD disks, any of CD-ROM disks (i.e., read-only optical storage disks), CD-R disks (i.e., write-once, read-many optical storage disks), and CD-RW disks (i.e., rewriteable optical storage disks); and electronic storage media, such as RAM, ROM, EPROM, Compact Flash cards, PCMCIA cards, or alternatively SD or SDIO memory; and the electronic components (e.g., floppy disk drive, DVD drive, CD/CD-R/CD-RW drive, or Compact Flash/PCMCIA/SD adapter) that accommodate and read from and/or write to the storage media. As is known to those of skill in the machine-readable storage media arts, new media and formats for data storage are continually being devised, and any convenient, commercially available storage medium and corresponding read/write device that may become available in the future is likely to be appropriate for use, especially if it provides any of a greater storage capacity, a higher access speed, a smaller size, and a lower cost per bit of stored information. Well known older machine-readable media are also available for use under certain conditions, such as punched paper tape or cards, magnetic recording on tape or wire, optical or magnetic reading of printed characters (e.g., OCR and magnetically encoded symbols) and machine-readable symbols such as one and two dimensional bar codes.

Many functions of electrical and electronic apparatus can be implemented in hardware (for example, hard-wired logic), in software (for example, logic encoded in a program operating on a general purpose processor), and in firmware (for example, logic encoded in a non-volatile memory that is invoked for operation on a processor as required). The present invention contemplates the substitution of one implementation of hardware, firmware and software for another implementation of the equivalent functionality using a different one of hardware, firmware and software. To the extent that an implementation can be represented mathematically by a transfer function, that is, a specified response is generated at an output terminal for a specific excitation applied to an input terminal of a “black box” exhibiting the transfer function, any implementation of the transfer function, including any combination of hardware, firmware and software implementations of portions or segments of the transfer function, is contemplated herein.

While the present invention has been particularly shown and described with reference to the structure and methods disclosed herein and as illustrated in the drawings, it is not confined to the details set forth and this invention is intended to cover any modifications and changes as may come within the scope and spirit of the following claims.

What is claimed is:

1. A pattern recognition processor, comprising:
a first optical path comprising a first spatial light modulator and a first Fourier lens, said first spatial light modulator configured to accept an input digital image and said first Fourier lens providing a spectrum of said input digital image;
a second optical path comprising a second input spatial light modulator and a second Fourier lens, said second spatial light modulator configured to accept a reference digital image and said second Fourier lens providing a spectrum of said reference digital image, said second optical path oriented in a non-parallel orientation to said first optical path;
a holographic film having a response time and an erase time, said holographic film situated at an intersection of a common Fourier transform plane of said spectrum of said input digital image and said spectrum of said reference digital image, said holographic film configured to record the holographic interference fringes that are formed as a hologram;
a first laser for illuminating said first spatial light modulator, said first Fourier lens, said second spatial light modulator, and said second Fourier lens to record said hologram, said first laser illuminating said holographic film from a first side; and
a second laser source configured to propagate a laser beam through said holographic film from a side different from said first side, a third Fourier lens configured to perform an inverse Fourier transform, and a sensor configured to sense a correlation output signal.

2. The pattern recognition processor of claim 1, wherein said holographic film is a holographic photopolymer film.

3. The pattern recognition processor of claim 1, wherein said record time of said holographic film is comparable to a single video frame display time.

4. The pattern recognition processor of claim 1, wherein said erase time is substantially instantaneous.

5. A real-time pattern recognition system, comprising:
said pattern recognition processor of claim 1;
a source of a digital input image for said first spatial light modulator;
a source of a reference input image for said second spatial light modulator; and
a controller and analyzer comprising a general purpose programmable computer and control software configured to control the operation of said real-time pattern recognition system, and to perform a responsive action based at least in part upon said correlation output signal.

6. The real-time pattern recognition system of claim 5, wherein said source of a digital image for said first spatial light modulator is a source of biometric images.

7. The real-time pattern recognition system of claim 6, wherein said source of biometric images is a fingerprint reader.

8. A method of pattern recognition in real time, comprising the steps of:
providing said pattern recognition processor of claim 1;
providing a digital input image to said first spatial light modulator;
providing a reference input image to said second spatial light modulator;
illuminating said first optical path and said second optical path with said first laser;
recording a hologram on said holographic film;
illuminating said recorded holographic film with said second laser;
sensing a correlation output signal with said sensor; and
determining a value for a cross-correlation of said input image and said reference image.

9. The method of pattern recognition in real time of claim 8, further comprising the step of taking an action based at least in part on said value of said cross-correlation of said input image and said reference image.

10. The method of pattern recognition in real time of claim 9, wherein said action is taken is responsive to a successful matching of said input image and said reference image.

11. The method of pattern recognition in real time of claim 9, wherein said action is taken is responsive to an unsuccessful matching of said input image and said reference image.

12. The method of pattern recognition in real time of claim 8, wherein said operation of said first laser and said second laser is performed in pulsed mode, said first laser and said second laser operating in succession.

13. The method of pattern recognition in real time of claim 12, wherein said operation of said first laser and said second laser is performed repeatedly in pulsed mode.

14. The method of pattern recognition in real time of claim 12, wherein said operation of said first laser and said second laser is performed in substantially real time.

15. The method of pattern recognition in real time of claim 12, wherein said operation of said first laser and said second laser is performed in substantially a time required to display a single video frame.
